(19) United States
(12) Patent Application Publication
(10) Pub. No.: US 2014/0008935 A1
(43) Pub. Date: Jan. 9, 2014

(54) FOLDING TOP FOR A MOTOR VEHICLE

(71) Applicant: Dr. Ing. h.c.F. Porsche Aktiengesellschaft, Stuttgart (DE)

(72) Inventors: Mathias Froeschle, Ostfildern (DE); Timo Czechtizky, Zell u. A. (DE)

(21) Appl. No.: 13/933,716

(22) Filed: Jul. 2, 2013

(30) Foreign Application Priority Data
Jul. 5, 2012 (DE) 10 2012 106 027.4

(51) Int. Cl. B60J 7/12

(52) U.S. Cl. CPC B60J 7/1226
USPC 296/108

(57) ABSTRACT

A folding top has a folding-top cloth with has fins that are directed toward a rear cover. The fins are arranged on the rear cover in a closed position of the folding top. The fins of the folding-top cloth are pivotable about an axis of rotation via laterally arranged fin links on the folding-top frame. The folding-top cloth can be moved from a braced position into an open position, and vice versa by an adjusting device between the rear cover and the fin link.

### CROSS REFERENCE TO RELATED APPLICATION

This application claims priority under 35 USC 119 to German Patent Appl. No. 10 2012 106 027.4 filed on Jul. 5, 2012, the entire disclosure of which is incorporated herein by reference.

### BACKGROUND

1. Field of the Invention

The invention relates to a folding top for a motor vehicle.

2. Description of the Related Art

DE 10 2008 036 910 A1 discloses a folding roof having a folding-top cloth that is held on the vehicle via a folding-top frame. Rear fins of the folding roof are held in a pretensioned manner via tensioning elements.

It is the object of the invention to provide a folding top for a motor vehicle having a folding-top cloth with fins, which folding top can be transferred in a simple manner from a pretensioned closing position into a relaxed open position, and vice versa.

### SUMMARY OF THE INVENTION

The invention relates to a folding top with a folding top cloth that has fins. The folding top can be moved into various folding-top positions in a simple procedure with the aid of an adjusting device. The fins of the folding-top cloth are arranged to be pivotable about an axis of rotation via lateral fin links on a folding-top frame. Additionally, the folding-top cloth can be moved from a braced position into an open position, and vice versa, by means of an adjusting device between the rear cover and fin links of the folding-top frame.

Each fin link has an angle lever with two lever arms. The fins are held with the first lever arm on the end side thereof via fin tips and an actuating element of the adjusting device is arranged at the free end of the second lever arm.

A coupling member preferably is arranged on the rear cover and interacts with the actuating element on the first lever arm of the fin link. During a closing movement of the rear cover together with the actuating element, the coupling member moves the actuating element down and hence the folding top can be adjusted into the closed position or braced position.

The adjusting device comprises the actuating element on the folding top and the coupling member on the cover, and makes it possible in a simple manner to achieve a closed position or braced position of the folding-top cloth and hence the folding top by means of the pivoting movement of the rear cover.

It is likewise possible to achieve the open position from the closed position in a simple manner in that the rear cover is opened. In this case, the fin link is pivoted via a prestressed spring element from the braced position into the open position of the folding top. The spring element is arranged between the free end of the first lever arm and the axis of rotation on the folding-top frame. The prestressed spring element automatically causes an upward pivoting of the rear end of the folding-top cloth with the fins, and the elements of the adjusting device are released from one another. From this position, it is also possible to store the folding top in a storage space of the vehicle.

The actuating element on the free end of the second lever arm preferably is spherical and the coupling member preferably has a concave, smooth receiving shell that positively receives the spherical actuating element. This reception achieves a secure contact between the spherical actuating element and the concave receiving shell and compensates for tolerances, since the spherical actuating element can be threaded into the receiving shell. The spherical actuating element also may comprise a spring-loaded ball.

An exemplary embodiment of the invention is illustrated in the drawings and will be described in further detail below.

### BRIEF DESCRIPTION OF THE DRAWINGS

FIG. 1 is a side view of a vehicle with a folding top having lateral fins.

FIG. 2 is a section along the line II-II of FIG. 1 through a fin of the folding top.

FIG. 3 is a section along the line III-III of FIG. 1 through a so-called fin tip.

FIG. 4 shows an open position of the folding top with upwardly pivoted rear cover.

FIG. 5 shows a pre-braced position of the folding top, in which the elements of the adjusting device are in contact with one another.

### DETAILED DESCRIPTION OF THE PREFERRED EMBODIMENTS

A folding top 1 for a motor vehicle has a folding-top cloth 2 with fins 3 that are directed toward a rear cover 4. Each fin 3 is pivotable about an axis 7 via a lateral fin link 5 on the folding-top frame 6. The folding-top cloth 2 with the fins 3 can be moved from a braced position I into an open position, and vice versa, via an adjusting device 8 between the rear cover 4 and the fin link 5. A fin tip 9 is provided at the end of each fin 3. The contour of the fins 3 is supported by a longitudinally extending linkage 10, 11.

The fin link 5 comprises an angle lever with two lever arms 12, 14. The fin tip 9 is held on the end of the first lever arm 12 and an actuating element 15 of the adjusting device 8 is arranged on the free end of the second lever arm 14.

A coupling member 16 is arranged on the rear cover 4 and interacts with the actuating element 15 on the first lever arm 12 of the fin link 5. The coupling member 16 is adjustable with the actuating element 15 in a downwardly moving manner during closing of the rear cover 4 in arrow direction P.

The fin link 5 can be pivoted via a prestressed spring element 17 from the braced position I into the open position of the folding top 1. The spring element 17 is arranged between the free end of the first lever arm 12 and the axis of rotation 7 on the folding-top frame 6.

The actuating element 15 on the free end of the second lever arm 14 of the fin link 5 is spherical and preferably ball-shaped, and the coupling member 16 comprises a concave, smooth receiving shell that positively receives the actuating element 15 when contact is made.

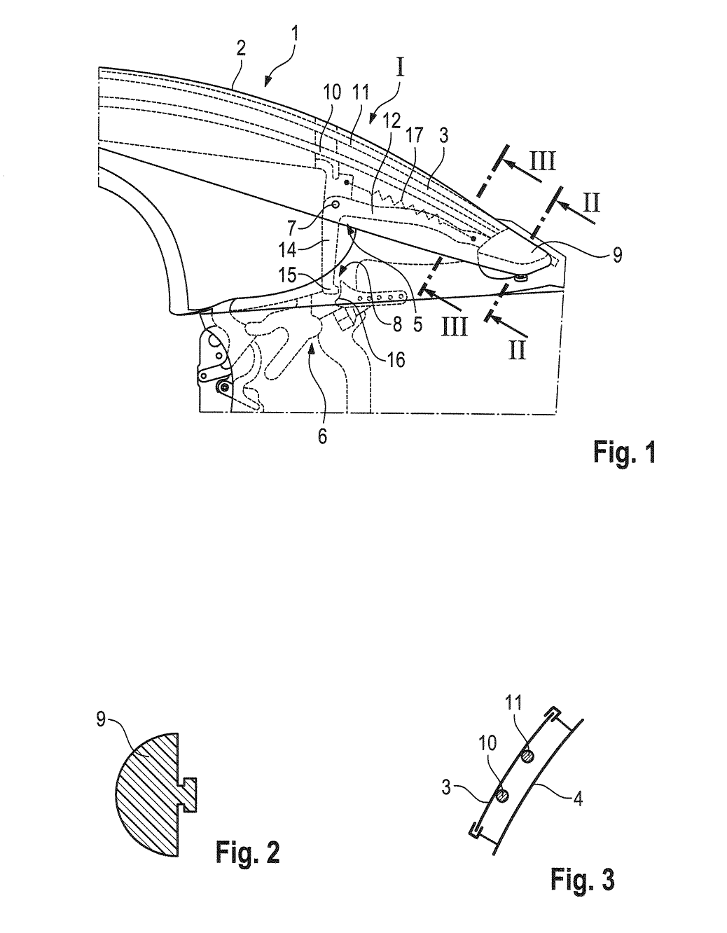

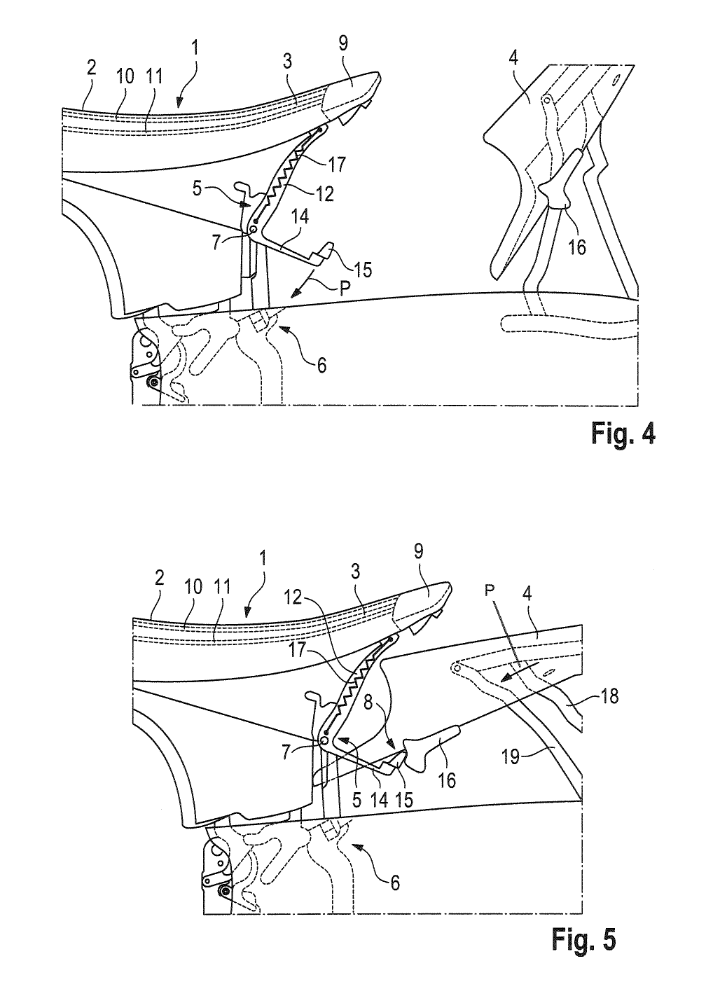

The rear cover 4 can be transferred by links 18, 19 from the open position (FIG. 4) into the closed position (FIG. 1) and vice versa, with the coupling member 16 making contact with the actuating element 15 and the fin link 5 with the fins of the folding-top cloth 2 being pivotable into the braced position I with bracing of the spring element 17.

What is claimed is:

1. A folding top for a motor vehicle having a folding-top cloth with fins directed toward a rear cover, the fins being arranged on the rear cover in a closed position of the folding top, the fins of the folding-top cloth being pivotable about an axis of rotation via lateral fin links on a folding-top frame, and the folding-top cloth being moveable between a braced position (I) and an open position by an adjusting device between the rear cover and the fin link.

2. The folding top of claim 1, wherein the fin link comprises an angle lever with first and second lever arms, the fins having fin tips held on a free end of the first lever arm remote from the second lever arm, and an actuating element of the adjusting device being arranged at a free end of the second lever arm remote from the first lever arm.

3. The folding top of claim 2, further comprising a coupling member arranged on the rear cover and interacting with the actuating element on the first lever arm of the fin link during a closing movement of the rear cover together with the actuating element the coupling member moving the actuating element down and adjusting the folding top cloth into the braced position (I).

4. The folding top of claim 2, further comprising a prestressed spring element arranged between the free end of the first lever arm and the axis of rotation on the folding-top frame for pivoting the fin link from the braced position (I) into the open position of the folding top.

5. The folding top of claim 2, wherein the actuating element on the free end of the second lever arm is spherical and the coupling member comprises a concave, smooth receiving shell that positively receives the spherical actuating element.

6. The folding top of claim 1, wherein the rear cover can be transferred by links from the open position into the closed position, the coupling member making contact with the actuating element and the fin link with the fins of the folding-top cloth being pivotable into the braced position (I) with bracing of the spring element.
